(19) United States
(12) Patent Application Publication
(10) Pub. No.: US 2017/0092026 A1
(43) Pub. Date: Mar. 30, 2017

(54) LOW-POWER ACCESS AUTHENTICATION

(71) Applicant: Faraday&Future Inc., Gardena, CA (US)

(72) Inventors: Daniel L. Kowalewski, Redondo Beach, CA (US); Matthew Richard Partsch, San Pedro, CA (US); Cian John Francis Brogan, Los Angeles, CA (US)

(21) Appl. No.: 15/272,188

(22) Filed: Sep. 21, 2016

Related U.S. Application Data
(60) Provisional application No. 62/233,143, filed on Sep. 25, 2015.

(51) Int. Cl. G07C 9/00

(52) U.S. Cl. CPC G07C 9/00007; G07C 9/00309; G07C 2009/00317; G07C 2009/00769

(57) ABSTRACT

An authentication-based multi-stage powering scheme is disclosed. An initial authentication stage can include low-power components to sense user initialization signal and authenticate the user. When the user is authenticated the vehicle system can be initialized and one or more subsequent sensing components can be powered up and activated. When the one or more subsequent sensing components receives further user information, such as user proximity to the vehicle, subsequent parts of the vehicle system can be powered up and activated to allow user access to the vehicle.

### RELATED APPLICATIONS

This application claims the benefit of U.S. Provisional Application Ser. No. 62/233,143, filed on Sep. 25, 2015, entitled “LOW-POWER ACCESS AUTHENTICATION,” the entirety of which is hereby incorporated by reference in its entirety and for all purposes.

### BACKGROUND

### Field

The described technology generated relates to automobiles and, more specifically, to access authentication.

### Description of the Related Art

Power consumption in automotive applications is becoming increasingly important as more and more electronic controllers/processors/components are being added to modern designs. If all systems in a vehicle were continually powered so as to be maintained in a ready to use state, there would be no delays in using any particular feature or function of the vehicle at the moment a user of the vehicle desires. However, continual powering may idly consume battery power and shorten how long a vehicle can remain operational without being recharged.

### SUMMARY

The methods and devices of the described technology each have several aspects, no single one of which is solely responsible for its desirable attributes.

In one embodiment, an electric vehicle is described. The electric vehicle includes an initialization signal detector, initial authentication circuitry, and one or more subsequent signal detectors. The initial authentication circuitry can be activated by the initialization signal detector. A subsequent signal detector can be activated by the initial authentication circuitry. The electric vehicle can further include access authorization circuitry activated by a subsequent signal detector. The electric vehicle can further include operation authorization circuitry activated by a subsequent signal detector. The electric vehicle can further include authorization circuitry configured to authorize one or more vehicle functions, the authorization circuitry activated by a subsequent signal detector. The initialization signal detector can be configured to detect at least one of a radio frequency signal and an infrared signal.

In another embodiment, a method for enabling authorized use of a vehicle is described. The method includes receiving an initialization signal, initializing the vehicle upon receiving the initialization signal, receiving a subsequent signal, and authorizing access to the vehicle upon receiving the subsequent signal. The method can further include authorizing operation of the vehicle. The method can further include receiving a third signal, wherein authorizing operation of the vehicle occurs based at least in part on receiving the third signal. The operation of the vehicle can include activation of a powertrain of the vehicle. The method can further include authorizing one or more functions of the vehicle. The method can further include receiving a third signal, wherein authorizing one or more functions of the vehicle occurs based at least in part on receiving the third signal. The initialization signal and the subsequent signal can include at least one of a short field radio frequency signal and an infrared signal.

In another embodiment, a system is described. The system includes a portable interface and an electric vehicle. The electric vehicle includes an initialization signal detector configured to detect the portable interface, initial authentication circuitry, and one or more subsequent signal detectors. A subsequent signal detector can be activated by the initial authentication circuitry. The electric vehicle can further include access authorization circuitry. The portable interface can include at least one of a key fob and a personal electronic device. The portable interface can be configured to communicate with the initialization signal detector by at least one of short field radio frequency, passive radio frequency, and infrared.

### BRIEF DESCRIPTION OF THE DRAWINGS

These drawings and the associated description herein are provided to illustrate specific embodiments of the invention and are not intended to be limiting.

FIG. 1 is a block diagram illustrating an example access authentication powering scheme according to one embodiment.

FIG. 2 is a flowchart showing an example access authentication process according to one embodiment.

### DETAILED DESCRIPTION

Various aspects of the novel systems, apparatuses, and methods are described more fully hereinafter with reference to the accompanying drawings. Aspects of this disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the novel systems, apparatuses, and methods disclosed herein, whether implemented independently of or combined with any other aspect. For example, an apparatus may be implemented or a method may be practiced using any number of the aspects set forth herein. In addition, the scope is intended to encompass such an apparatus or method which is practiced using other structure, functionality, or structure and functionality in addition to or other than the various aspects set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to automotive systems and/or different wired and wireless technologies, system configurations, networks, including optical networks, hard disks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

An authentication-based multi-stage powering scheme is disclosed. An initial authentication stage can include low-power components to sense user initialization signal and authenticate the user. When the user is authenticated the vehicle system can be initialized and one or more subsequent sensing components can be powered up and activated. When the one or more subsequent sensing components receives further user information, such as user proximity to the vehicle, subsequent parts of the vehicle system can be powered up and activated to allow user access to the vehicle. This access may be provided without the delays often associated with such access, and also without significant cost in power consumption.

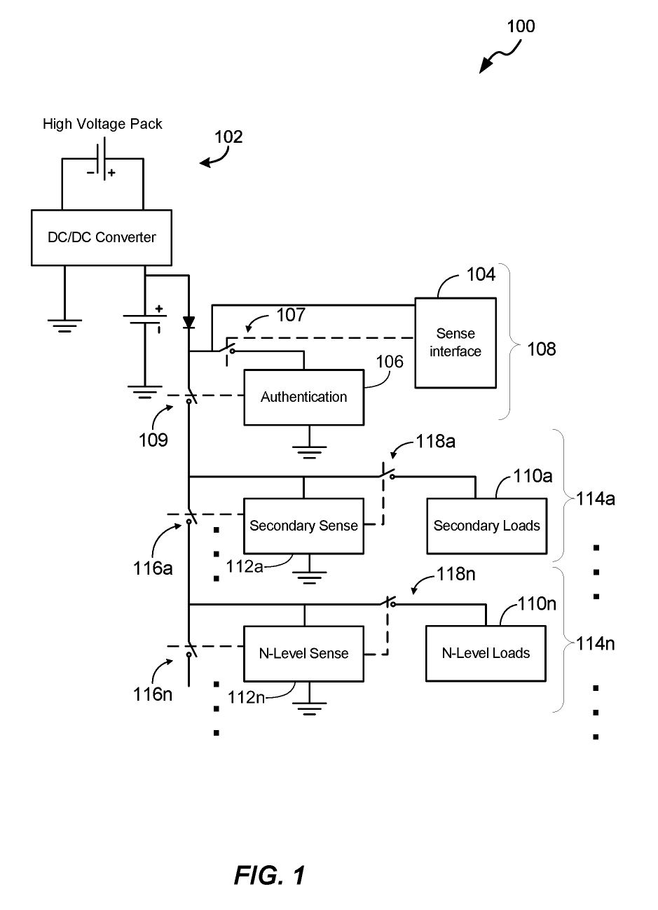

FIG. 1 is a block diagram illustrating an example access authentication powering scheme according to one embodiment. The illustrated system 100 includes power source 102, an initial authentication stage 108, and one or more subsequent authorization stages 114a, . . . , 114n, . . . , collectively referred to herein as the subsequent or Nth-level authorization stage(s) 114. The initial authentication stage 108 further includes an initial sense interface 104 and a switch 107 operated by the sense interface 104 to power up or otherwise activate an authentication circuit 106. The authentication circuit 106 may include another switch 109 for providing power or otherwise activating a next subsequent authorization stage 114a under the control of the authentication circuit 106. Each of the subsequent authorization stages 114 may include a sense interface 112 (e.g., secondary sense interface 112a, . . . , Nth-level sense interface 112n, . . . ), loads 110 (e.g., secondary loads 110a, . . . Nth-level loads 110n, . . . ), and one or more subsequent powering switches 118 (e.g., secondary powering switches 116a, 118a, . . . , Nth level powering switches 116n, 118n, . . . ). It is to be noted that although the powering switches 109, 116, 118 are each represented as a single switch in FIG. 1, the powering switches 109, 116, 118 can be implemented with any other circuits or in conjunction with other circuit elements (e.g., inverter) that enable powering subsequent circuits or waking up subsequent devices in sleep modes based on one or more signals they receive. The techniques disclosed herein can be implemented in conjunction with low-power “sleep mode” technologies, and “enabling” and “activating” as used herein can be understood either as a full powering up of fully powered-down components or as waking up of components in a low-power sleep mode.

The power source 102 can include one or more batteries such as rechargeable traction batteries or high voltage battery pack suitable for electric vehicles (e.g., lead-acid, nickel-cadmium, lithium ion, etc.). Power provided by the power source 102 can be coupled to a DC/DC converter to convert the voltage to a level suitable (e.g., 12V) for functioning of certain local electronics or other circuit elements. As further discussed below, in some embodiments when the system incorporating the multi-stage powering scheme disclosed herein (e.g., an electric vehicle) is powered off, only the initial sense interface 104 may be powered, and the initial sense interface 104 may be powered only to the extent it is sufficiently responsive to preserve the battery life of the power source 102.

The initial sense interface 104 can include one or more electronic components having low power or low duty cycle. The initial sense interface 104 can be configured to detect signals from a portable authentication device, such as a dedicated fob, multi-function device (e.g., a smartwatch or a smartphone), or any other similar portable user interface device. In some embodiments, the initial sense interface 104 can receive user inputs through a portable user interface (e.g., fob) indicating the user's intent to initialize the vehicle soon. Also, in some embodiments, the initial sense interface 104 can be configured to communicate with a portable user interface through long-range communication protocols such that the vehicle can be initialized without the user with the portable user interface in the close vicinity of the vehicle. In some embodiments, detection of a signal from a portable user interface may trigger enabling or activating of the authentication circuit 106. In other embodiments, the authentication circuit 106 along with the initial sense interface 104 can both be powered and activated at least partially in time to allow, for example, higher responsiveness.

The authentication circuit 106 can include one or more electronic components configured to validate a user. The authentication circuit 106 can use technology for validating a user that may be tailored to one or more specific use cases. For example, the authentication circuit 106 may communicate with a portable user interface through various communication methods, channels, and/or protocols using technologies, such as short field radio frequency (RF), passive RF, or infra-red (IR). In other instances, the authentication circuit 106 may validate the user through physical touch, visual information of the user, or other similar methods utilizing the user's presence and physical information. In some embodiments, the authentication circuit 106, if activated as needed, can determine whether the holder of the portable user interface device is an individual authorized to access the vehicle. For example, the authentication circuit 106, once activated, can execute encrypted hash or other similar instructions to authenticate the user of the vehicle. In other embodiments, the authentication circuit 106 may further determine whether the holder of the portable user interface device is an individual authorized to operate or use other functions of the vehicle. Depending on the desired level of power conservation and early authentication or initialization, more or less determination regarding the user and the extent of the user's authorized status can be made by the authentication circuit 106.

The initial sense interface 104, the authentication circuit 106, and the powering switches 107 and 109, together can implement the initial authentication stage 108. Rather than having various controllers, processors, or components of a comprehensive system, such as an electric vehicle, powered and activated continually, it can be advantageous to have the minimal initial interface sensor(s) (e.g., the initial sense interface 104) activated with low power and strategically power the remaining parts of the electric vehicle in one or more subsequent stages based in part on, for example, the natural progression of a user in the course of planning a trip on a currently powered off vehicle, approaching the vehicle, opening the door of the vehicle, entering and sitting down in the vehicle, and driving away with the vehicle. As such, the initial authentication stage 108 can be understood as the user planning to drive a powered off vehicle and communicating that intent either actively or passively. As further described below, the subsequent one or more authorization stages 114 can be understood as the system 100 implemented in an electric vehicle, for example, obtaining one or more signals, data, or information (either communicated actively or passively by the user) from and/or about the user so that parts of the vehicle can be selectively powered up in the sequence of the user's natural, intended, and/or authorized use of the vehicle. The overall system, such as a vehicle, can implement two or more stages or authentication and power-up schemes as disclosed herein based on balancing the adequate levels of power conservation and system responsiveness.

The next subsequent sense interface 112a can include one or more electronic components configured to detect signals from the portable user interface and/or otherwise sense or gather user information regarding, for example, the user's approaching the vehicle, presence near the vehicle, physical contact with the vehicle, etc. In some embodiments, the subsequent sense interface 112 can be implemented with one or more proximity sensors or other sensors using technologies, such as RF (e.g., Bluetooth, Wi-Fi), IR, etc. to detect or sense various indications that the user is getting closer to accessing and operating in terms of time or physical progression. For example, in some embodiments, the subsequent sense interface 112a can be implemented using one or more proximity sensors so that the subsequent sense interface 112a can detect the user approaching the vehicle and power up or wake up devices or the subsequent loads 110 that are commensurate parts of the vehicle system to be enabled in anticipation of the user approaching and accessing the vehicle. The subsequent sense interface 112a can power up or wake up the subsequent loads 110 through the powering switch 118, which can be implemented with other circuits that enable or wake up the subsequent loads 110 as discussed above. In embodiments with multiple levels of subsequent authorization stages 114a . . . 114n . . . , the subsequent sense interface (e.g., 112a) can power up or wake up the next level of sense interface (e.g., 112b) through the powering switch 116, which can be implemented with other circuits that enable or wake up the next level subsequent sense interface.

The subsequent loads 110 can be parts of the vehicle that are enabled upon signals or indications of the user nearing access of the vehicle. For example, the subsequent loads 110 can include parts of the vehicle pertaining to door locks based on the data received by the subsequent sense interface 112 (e.g., proximity sensor). In this example, upon arrival of an authorized user at a door of the vehicle, the authorized user can seamlessly gain access to the door without further active communication (e.g., pressing a button to unlock the door) or any other extra steps or further delay in responsiveness. In some embodiments, two or more subsequent authorization stages 114 can be implemented and depending on the level of authorized use of a particular user, the vehicle system can selectively enable parts of the vehicle. For example, the initial sense interface 104 or the subsequent sense interface 112 may receive identifying information about the user that indicates that the user is a minor through a fob or other device assigned to a minor, and based on this information, only the subsequent loads pertaining to access and the entertainment system can be enabled without enabling other operation (e.g., driving functionality) of the vehicle. In some instances, embodiments having two or more subsequent authorization stages 114 can be subsequently enabled with some time delay without further authentications or determinations of the identity or authorized use of the user.

The subsequent sense interface 112, the subsequent powering switches 116, 118, together can implement the subsequent authorization stage 114. The disclosed herein can be advantageous as the vehicle system can be highly responsive to the signals and indications from the authorized user (authenticated or authorized through the initial authentication stage 108 and at least one subsequent authorization stage 114) to provide a seamless access and operability of the vehicle with minimum or low power while disallowing unauthorized users or selectively allowing users with limited authorization to access or operate the vehicle. In some embodiments, it can be advantageous to implement parts or all of the initial authentication stage 108 (e.g., the initial sense interface 104) with devices and technologies that consume a minimum amount of power while performing at an adequate level as a gateway to power up and initialize the vehicle system and to defer to the subsequent authorization stage(s) 114 to perform more power consuming sensing and authentication processes.

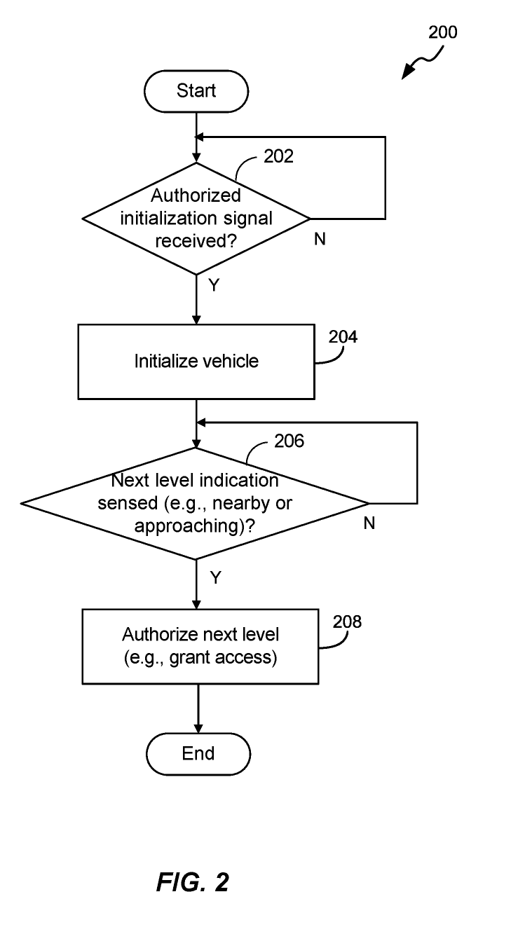

FIG. 2 is a flowchart showing an example access authentication process according to one embodiment. The illustrated process 200 shows one example embodiment of the disclosed herein that includes an initial authentication stage (e.g., the initial authentication stage 108) and one subsequent authorization stage (e.g., the subsequent authorization stage 114a). The one or more steps of the process 200 can be performed in part by and/or in conjunction with one or more elements described in connection with FIG. 1 above. It is to be noted that all or parts of steps 202, 204, 206, and 208 may be concurrently, continuously, periodically, intermittently, repeatedly, or iteratively performed, and the illustrated process in FIG. 2 is only one example embodiment of the features disclosed herein.

In step 202, only the minimum components of the vehicle system (e.g., the initial sense interface 104) are powered or partially powered to determine whether an authorized initialization signal is received. If, for example, the initial sense interface 104 does not receive any signal or indication that a user is nearby or intends to use the vehicle soon (e.g., via a fob), only the minimum components are at least partially powered to await a signal otherwise. If the initial sense interface 104 receives or detects a signal or indication that the user will use the vehicle soon, the user authentication can be performed by the authentication circuit 106 as described above, and the process 200 proceeds to step 204.

In step 204, the vehicle is initialized upon receipt of user signals with the initial sense interface 104 and authentication with the authentication circuit 106. In some embodiments, the initialization in step 204 may entail performing additional or deferred authentication processes and/or activating subsequent sensing interface 112 discussed above in connection with FIG. 1.

In step 206, an activated subsequent sense interface (e.g., 112a) of the initialized vehicle may determine if any next level indications are sensed or received. For example, a proximity sensor or Bluetooth receiver may detect that a user holding a portable user interface device is a few steps away from the vehicle or otherwise nearby or approaching the vehicle. If a next level indication is sensed, the process 200 may proceed to step 208. In some embodiments, upon not sensing or receiving any further indication from the user or the user device over a period time, the vehicle system may disable or power off parts or all of the vehicle that have been initialized in step 204. For example, the user may have indicated through a key fob that the user intends to use the vehicle soon, but before approaching the vehicle closely enough for it to sense the user and proceed to step 208, the user may decide to not drive and move further way from the vehicle. Instead of staying idle at step 206 with parts of the vehicle initialized, the process 200 may disable the initialized parts of the vehicle to return to the vehicle state in step 202.

In step 208, upon receipt of next level indication from the user or user device, next level access or operation is activated for the authorized user to use. For example, based on detecting of the user a few steps away from the vehicle, the subsequent sense interface in the previous example (e.g., 112a) may power up door locking and unlocking mechanism and grant access to the nearby user by unlocking the door. It is to be noted that the disclosed herein can be implemented with multiple subsequent authorization stages 114 (FIG. 1), in which case the process may further include more steps similar to steps 206 and 208 until the full functionality of the vehicle is powered and activated. For example, in some embodiments, the next level indication can be determined by one or more sensors configured to detect the user sitting down on the driver's seat, and upon detecting this next level indication, the vehicle system may power up parts of the vehicle responsible for operation (e.g., driving) of the vehicle. In other embodiments, without further sensing of indications or authorizations, a series of power up schemes can follow step 208 with a short time delay generally reflective of normal or common time delays (e.g., a few seconds) associated with a usual driver opening the door, sitting down, buckling up, and drive.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules, and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

### APPLICATIONS

It is to be understood that the implementations are not limited to the precise configuration and components illustrated above. Various modifications, changes and variations may be made in the arrangement, operation and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. An electric vehicle comprising:
an initialization signal detector;
initial authentication circuitry; and
one or more subsequent signal detectors.

2. The electric vehicle of claim 1, wherein the initial authentication circuitry is activated by the initialization signal detector.

3. The electric vehicle of claim 2, wherein a subsequent signal detector is activated by the initial authentication circuitry.

4. The electric vehicle of claim 1 further comprising access authorization circuitry activated by a subsequent signal detector.

5. The electric vehicle of claim 1 further comprising operation authorization circuitry activated by a subsequent signal detector.

6. The electric vehicle of claim 1 further comprising authorization circuitry configured to authorize one or more vehicle functions, the authorization circuitry activated by a subsequent signal detector.

7. The electric vehicle of claim 1, wherein the initialization signal detector is configured to detect at least one of a radio frequency signal and an infrared signal.

8. A method for enabling authorized use of a vehicle comprising:
receiving an initialization signal;
initializing the vehicle upon receiving the initialization signal;
receiving a subsequent signal; and
authorizing access to the vehicle upon receiving the subsequent signal.

9. The method of claim 8 further comprising authorizing operation of the vehicle.

10. The method of claim 9 further comprising receiving a third signal, wherein authorizing operation of the vehicle occurs based at least in part on receiving the third signal.

11. The method of claim 9, wherein the operation of the vehicle comprises activation of a powertrain of the vehicle.

12. The method of claim 8 further comprising authorizing one or more functions of the vehicle.

13. The method of claim 12 further comprising receiving a third signal, wherein authorizing one or more functions of the vehicle occurs based at least in part on receiving the third signal.

14. The method of claim 8, wherein the initialization signal and the subsequent signal comprise at least one of a short field radio frequency signal and an infrared signal.

15. A system comprising:
a portable interface; and
an electric vehicle comprising:
an initialization signal detector configured to detect the portable interface;
initial authentication circuitry; and
one or more subsequent signal detectors.

16. The system of claim 15, wherein a subsequent signal detector is activated by the initial authentication circuitry.

17. The system of claim 15, wherein the electric vehicle further comprises access authorization circuitry.

18. The system of claim 15, wherein the portable interface comprises at least one of a key fob and a personal electronic device.

19. The system of claim 15, wherein the portable interface is configured to communicate with the initialization signal detector by at least one of short field radio frequency, passive radio frequency, and infrared.
